(19) United States
(12) Patent Application Publication
(10) Pub. No.: US 2026/0135192 A1
(43) Pub. Date: May 14, 2026

(54) BATTERY APPARATUS

(71) Applicant: SK On Co., Ltd., Seoul (KR)

(72) Inventors: Suk Ho SHIN, Daejeon (KR); Do Yun KWAK, Daejeon (KR); Se Hyeon KIM, Daejeon (KR); Ji Min KIM, Daejeon (KR); Seung Soo CHO, Daejeon (KR)

(21) Appl. No.: 19/370,767

(22) Filed: Oct. 28, 2025

(30) Foreign Application Priority Data
Nov. 14, 2024 (KR) 10-2024-0162365

(51) Int. Cl. H01M 10/6568; H01M 10/613; H01M 10/647; H01M 10/658; H01M 50/211

(52) U.S. Cl. CPC H01M 10/6568; H01M 10/613; H01M 10/647; H01M 10/658; H01M 50/211

(57) ABSTRACT

A battery apparatus according to an example embodiment of the present disclosure may include: a case including an accommodating space; a battery cell assembly accommodated in the case and including a plurality of battery cells; a cooling fluid provided in the accommodating space; and at least one cooling member interposed between the plurality of battery cells, wherein the at least one cooling member may include: a body region interposed between the plurality of battery cells; a first bent region bent on one side of the body region; and a second bent region bent on the other side of the body region.

### CROSS-REFERENCE TO RELATED APPLICATION(S)

This patent document claims the priority and benefits of Korean Patent Application No. 10-2024-0162365 filed on Nov. 14, 2024, the disclosure of which is incorporated herein by reference in its entirety.

### TECHNICAL FIELD

The present disclosure relates to a battery apparatus.

### BACKGROUND

Batteries are widely used not only in small electronic devices such as mobile phones and laptop computers, but also in medium-to large-scale mechanical devices such as electric vehicles (EV) and energy storage devices, and have the advantage of being rechargeable and reusable.

An electrode assembly, including a cathode plate and an anode plate, is accommodated in a case selected for an intended use thereof such as a pouch type, a square type, or a cylindrical type, and an electrolyte is supplied to manufacture a battery cell.

A plurality of battery cells may be connected via busbars to form a battery apparatus. Examples of such devices include battery modules and/or battery packs.

The battery apparatus may require cooling. The battery apparatus may be immersed in a cooling fluid, allowing for immersion cooling or immersion cooling.

Meanwhile, thermal propagation may occur in a battery apparatus due to overheating issues in at least one battery cell.

Therefore, cooling and thermal propagation prevention should be considered simultaneously during the manufacturing and use of battery apparatuses.

### SUMMARY

According to an aspect of the present disclosure, a battery apparatus having improving cooling efficiency is provided.

According to an aspect of the present disclosure, a battery apparatus capable of minimizing or preventing thermal propagation is provided.

Furthermore, the present disclosure may be widely applied to devices within green technology fields such as solar power generation and wind power generation.

Furthermore, the present disclosure may be applied to eco-friendly devices such as eco-friendly electric vehicles and hybrid vehicles, which aim to prevent climate change by reducing air pollution and greenhouse gas emissions.

A battery apparatus according to an embodiment of the present disclosure may include: a case including an accommodating space; a battery cell assembly accommodated in the case and including a plurality of battery cells; a cooling fluid provided in the accommodating space; and at least one cooling member interposed between the plurality of battery cells, and the at least one cooling member may include: a body region interposed between the plurality of battery cells; a first bent region bent on one side of the body region; and a second bent region bent on the other side of the body region.

In an embodiment, the battery apparatus may further include an insulating member interposed between the plurality of cooling members.

In an embodiment, the insulating member may be formed of a different material from the body region.

In an embodiment, in the plurality of cooling members, each of first bent regions may face each other with the insulating member interposed therebetween, and each of second bent regions may face each other with the insulating member interposed therebetween.

In an embodiment, the insulating member may be formed of a material having a lower thermal conductivity than the body region or a material including mica.

In an embodiment, the insulating member may be formed of a material including mica.

In an embodiment, the body region may be formed of a material including metal.

In an embodiment, the plurality of battery cells may be spaced apart from the case, and the first bent region and the second bent region may be disposed in a separation space formed by separating the plurality of battery cells from the case, and may face the case in the separation space.

In an embodiment, the first bent region and the second bent region may face each other in a thickness-direction cross-section of the at least one cooling member.

In an embodiment, the battery apparatus may further include a support member interposed between each of the first bent regions and the case.

In an embodiment, the support member may be formed of a material including at least one of polyurethane and silicone.

In an embodiment, each of the first bent regions and the support member may have a height higher than a height of one end of the battery cells in a thickness-direction cross-section of the plurality of battery cells.

In an embodiment, the plurality of battery cells may be spaced apart from the first bent region and the second bent region.

In an embodiment, the insulating member may be provided in plural, and a plurality of insulating members may be formed of different materials.

In an embodiment, the plurality of insulating member may include: a first insulating member facing a body region of one cooling member of the plurality of cooling members; and a second insulating member interposed between the first insulating member and a body region of another cooling member of the plurality of cooling members, and the second insulating member may be formed of a different material from the first insulating member.

In an embodiment, the first insulating member may be formed of a material including mica or silicone.

In an embodiment, the second insulating member may be formed of a material including mica or silicone.

In an embodiment, the battery apparatus may further include: a plurality of plate members surrounding the plurality of battery cells and disposed between the plurality of battery cells and the case in the accommodating space, and including at least one assembly support protrusion, and the case may include: at least one assembly support groove formed on an inner surface facing the plurality of plate members and into which the at least one assembly support protrusion is inserted.

In an embodiment, the cooling fluid may include an insulating oil, and the battery cell assembly and the at least one cooling member may be immersed in the cooling fluid.

In an embodiment, a battery apparatus may include: a case including an insulating oil or a cooling water in an accommodating space; a battery cell assembly including a plurality of battery cells immersed in the insulating oil or the cooling water in the accommodating space and spaced apart from the case; a plurality of cooling members interposed between the plurality of battery cells; and an insulating member interposed between the plurality of cooling members and formed of a different material from the plurality of cooling members, wherein the plurality of cooling members may respectively include a bent region disposed in a separation space formed by separating the plurality of battery cells from the case in the accommodating space.

In an embodiment, the bent region may include includes: a first bent region facing one side of the battery cell; and a second bent region facing the other side of the battery cell.

According to an aspect of the present disclosure, a battery apparatus capable of improving cooling efficiency may be provided.

According to an aspect of the present disclosure, a battery apparatus capable of minimizing or preventing thermal propagation may be provided.

Furthermore, the present disclosure may be widely applied to devices within green technology fields such as solar power generation and wind power generation.

Furthermore, the present disclosure may be applied to eco-friendly devices such as eco-friendly electric vehicles and hybrid vehicles, which aim to prevent climate change by reducing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic perspective view of a battery apparatus according to an embodiment of the present disclosure.

FIG. 2 is a schematic cross-sectional view taken along line I-I′ of FIG. 1.

FIG. 3 is a schematic cross-sectional view of a cooling member according to an embodiment of the present disclosure.

FIG. 4 is a schematic cross-sectional view of a plurality of cooling members according to an embodiment of the present disclosure.

FIG. 5 is a schematic cross-sectional view of a plurality of cooling members and an insulating member according to an embodiment of the present disclosure.

FIG. 6 is a schematic cross-sectional view of a plurality of cooling members, an insulating member and a support member according to an embodiment of the present disclosure.

FIG. 7 is a schematic cross-sectional view of a portion of a battery apparatus according to an embodiment of the present disclosure.

FIG. 8 is a schematic cross-sectional view of a portion of a battery apparatus according to an embodiment of the present disclosure.

FIG. 9 is a schematic exploded perspective view of a battery apparatus according to another embodiment of the present disclosure.

FIG. 10 is a schematic perspective view of a second case.

FIG. 11 is a schematic exploded perspective view of a second case and a plurality of plate members.

FIG. 12 is a schematic cross-sectional view of a battery apparatus according to an embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis depicted in the drawing represents a thickness direction of a battery cell 121, a Y-axis represents a height direction of the battery cell 121, and a Z-axis represents a width direction of the battery cell 121. However, these directions are arbitrarily set for ease of understanding, and the aforementioned directions may be modified and applied.

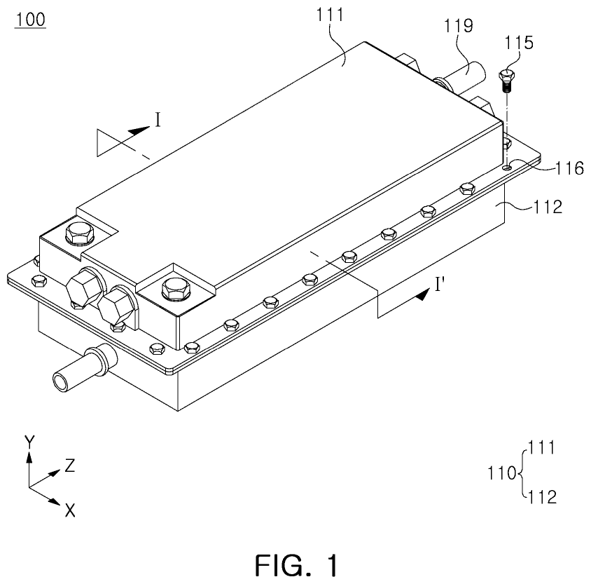

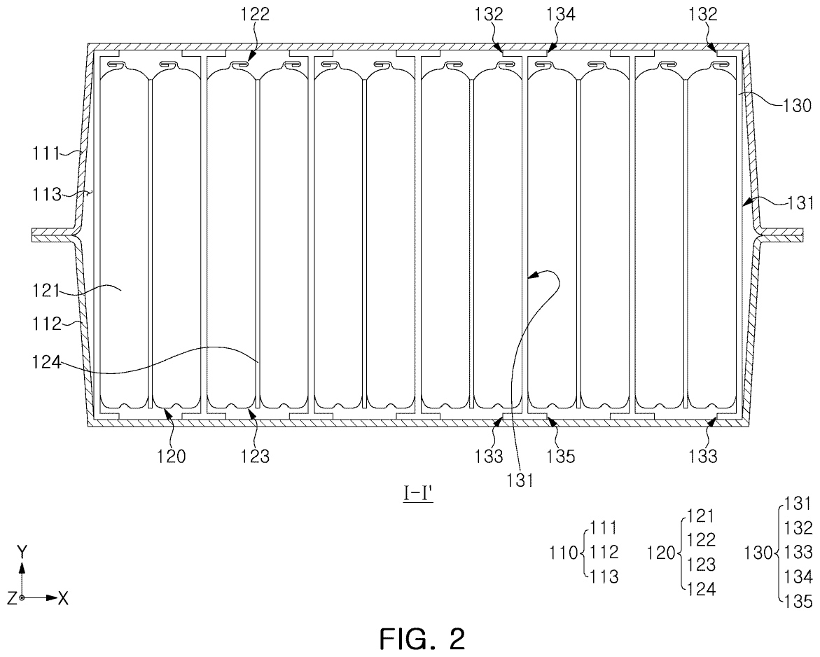

FIG. 1 is a schematic perspective view of a battery apparatus 100 according to an embodiment of the present disclosure, and FIG. 2 schematically illustrates a cross-section taken along line I-I′ of FIG. 1. In FIG. 2, a battery cell 121 is not depicted in cross-section.

As illustrated in FIGS. 1 and 2, a battery apparatus 100 according to an embodiment of the present disclosure may include a case 110 including an accommodating space 113, a battery cell assembly 120 accommodated in the case 110 and including a plurality of battery cells 121, a cooling fluid provided in the accommodating space 113, and at least one cooling member 130 interposed between the plurality of battery cells 121. The at least one cooling member 130 may include a body region 131 interposed between the plurality of battery cells 121, a first bent region 132 bent on one side of the body region 131, and a second bent region 133 bent on the other side of the body region 131.

In an embodiment, the case 110 may include a first case 111 and a second case 112. Each of the first case 111 and the second case 112 may include the accommodating space 113. The first case 111 and the second case 112 may have a certain level of rigidity.

In a state in which the first case 111 and the second case 112 are separated from each other and the accommodating space 113 is open, the battery cell assembly 120 may be accommodated in the accommodating space 113. In addition to the battery cell assembly 120, the accommodating space 113 may also accommodate components related to the battery cell assembly 120, such as a busbar.

Then, the first case 111 and the second case 112 may be disposed against each other, and a fixing member 115 may fastened to a coupling hole 116 provided in each of the first case 111 and the second case 112, thereby coupling the first case 111 and the second case 112.

A cooling fluid may be provided in the accommodating space 113. In an embodiment, the cooling fluid may include an insulating oil. Additionally, the battery cell assembly 120 may be immersed in the cooling fluid.

In an embodiment, the case 110 may include a cooling fluid supply portion 119. The cooling fluid supply portion 119 may be a cooling port. The cooling fluid may be supplied to the accommodating space 113 through the cooling port, or the cooling fluid supplied to the accommodating space 113 may be discharged to the outside of the case 110.

In some cases, the cooling fluid supply portion 119 may include a supply port for supplying the cooling fluid to the accommodating space 113 and a discharge port for discharging the cooling fluid from the accommodating space 113.

In an embodiment, the cooling fluid may be a fluid acting as an electrical insulator. For example, the cooling fluid may be an insulating oil primarily composed of non-conductive oil. However, the cooling fluid may be changed to another fluid within a range of fluids capable of cooling the battery apparatus 100.

In an embodiment, the battery cell assembly 120 may include a plurality of battery cells 121. An electrode assembly may be accommodated within the battery cell 121. The electrode assembly may include a cathode plate, an anode plate and a separator, and the electrode assembly and the electrolyte may be accommodated within the battery cell 121. In order to seal an interior of the battery cell 121, the battery cell 121 may include a sealing portion 122. The sealing portion 122 may be a portion of a region in which the battery cell 121 is sealed.

The battery cell 121 may be accommodated in the accommodating space 113. The battery cell 121 may be disposed so that a bottom surface 123 faces the second case 112 and the sealing portion 122 faces the first case 111. The bottom surface 123 of the battery cell 121 may be spaced apart from the sealing portion 122 in a height direction (Y-direction) of the battery cell 121.

In the battery cell 121, the electrode assembly accommodating space 113, which is a space in which the electrode assembly is accommodated, may be disposed between the sealing portion 122 and the bottom surface 123 in a thickness-direction cross-section (X-Y plane) of the battery cell 121.

A plurality of battery cells 121 may be stacked or arranged so that the electrode assembly accommodation spaces 113 in which the electrode assembly is accommodated face each other. In an embodiment, a pad member 124 may be provided between the plurality of battery cells 121. The pad member 124 may be formed of a material including mica, and may provide surface pressure to the battery cells 121 and serve to cool the battery cells 121.

At least one cooling member 130 may be interposed between the plurality of battery cells 121. In an embodiment, at least one cooling member 130 may include a body region 131 disposed in a region corresponding to the electrode assembly accommodating space 113 of the battery cell 121, a first bent region 132 bent in an end of the body region 131 in a +Y-direction, and a second bent region 133 bent in an end of the body region 131 in a −Y-direction.

In an embodiment, at least one cooling member 130 may be immersed in a cooling fluid in the accommodating space 113. In an embodiment, at least one cooling member 130 may include a plurality of cooling members 130. The plurality of cooling members 130 may be immersed in the cooling fluid.

All components disposed in the battery cell assembly 120 and the accommodating space 113 may be immersed in the cooling fluid.

In an embodiment, the first bent region 132 may face the sealing portion 122, and the second bent region 133 may face the bottom surface 123. Alternatively, in a thickness-direction cross-section (X-Y plane) of the battery cell 121, at least a portion of the first bent region 132 and at least a portion of the sealing portion 122 of the battery cell 121 may overlap each other in the height direction (Y-direction) of the battery cell 121.

Furthermore, in a thickness-direction cross-section (X-Y plane) of the battery cell 121, at least a portion of the second bent region 133 and at least a portion of the bottom surface 123 of the battery cell 121 may overlap each other in the height direction (Y-direction) of the battery cell 121.

The cooling member 130 may perform a heat dissipation function. The cooling member 130 may improve the cooling efficiency of a region corresponding to the electrode assembly accommodating space 113 in the battery cell 121. For example, the cooling member 130 may exchange heat with a cooling fluid through the first bent region 132 and the second bent region 133. In addition, the body region 131 connected to the first bent region 132 and the second bent region 133 may improve the cooling efficiency of a region corresponding to the electrode assembly accommodating space 113 in the battery cell 121.

In an embodiment, the plurality of cooling members 130 may have different types. For example, one cooling member 130 may include a body region 131, a first bent region 132, and a second bent region 133, and another cooling member 130 may include a body region 131, a first bent region 132, a second bent region 133, a third bent region 134, and a fourth bent region 135. In an embodiment, in the other cooling member 130, the body region 131, the first bent region 132, the second bent region 133, the third bent region 134 and the fourth bent region 135 may be formed of a single material. For example, the other cooling member 130 may be integral.

The third bent region 134 may face the first case 111 and may be a region bent in an end of the cooling member 130 in the +Y-direction. The third bent region 134 may face the first bent region 132 and may be bent in an opposite direction to a direction in which the first bent region 132 is bent.

The fourth bent region 135 may face the second case 112 and may be a region bent in an end of the cooling member 130 in the Y-direction. The fourth bent region 135 may face the second bent region 133 and may be bent in an opposite direction to a direction in which the second bent region 133 is bent.

In an embodiment, a cross-sectional shape of the battery cell 121 of the cooling member 130 including the first bent region 132, the second bent region 133, the third bent region 134 and the fourth bent region 135 in the thickness direction may have an “I” shape.

Furthermore, in an embodiment, the cross-sectional shape of the battery cell 121 of the cooling member 130 including the first bent region 132 and the second bent region 133 in a thickness direction may have a “]” or “[” shape. In some cases, a cooling member 130 having a “]” shape and a cooling member 130 having a “[” shape may be combined to form an “I” shaped cooling member 130.

The plurality of cooling members 130 may have various shapes, and the cooling members 130 having different shapes may be interposed between the plurality of battery cells 121.

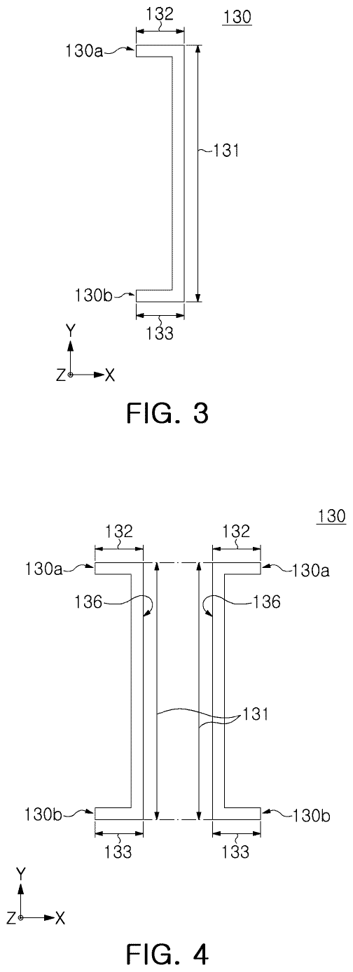

FIG. 3 schematically illustrates a cross-section of a cooling member 130 according to an embodiment of the present disclosure. FIG. 3 illustrates the cooling member 130 in a thickness direction (X-direction) cross-section of the battery cell 121. Hatching lines are not illustrated in FIG. 3.

As illustrated in FIG. 3, the cooling member 130 according to an embodiment of the present disclosure may include a body region 131. The first bent region 132 may extend to one side of the body region 131, and the second bent region 133 may extend to the other side of the body region 131.

The first bent region 132 may be formed by bending a first end 130a of the cooling member 130 in a first direction, and the second bent region 133 may be formed by bending a second end 130b of the cooling member 130 in a second direction.

The first direction may be a direction in which the first end 130a of the cooling member 130 rotates counterclockwise relative to the body region 131 in the thickness direction of the battery cell 121 or in the thickness-direction cross-section (X-Y plane) of the cooling member 130.

The second direction may be a direction in which the second end 130b of the cooling member 130 rotates clockwise relative to the body region 131 in the thickness direction of the battery cell 121 or in the thickness-direction cross-section (X-Y plane) of the cooling member 130.

In an embodiment, the first bent region 132 and the second bent region 133 may face each other in the thickness-direction cross-section (X-Y plane) of the at least one cooling member 130. That is, in the thickness-direction cross-section (X-Y plane) of the cooling member 130, at least a portion of the first bent region 132 and at least a portion of the second bent region 133 may overlap each other in the height direction (Y-direction) of the cooling member 130.

In an embodiment, the cooling member 130 may be formed of a material including metal. Furthermore, in an embodiment, the body region 131 of the cooling member 130 may be formed of a material including metal. For example, the body region 131 may be formed of a material including at least one of aluminum, stainless steel, or the like. Accordingly, a cooling member 130 having relatively high thermal conductivity may be implemented. In this manner, the cooling member 130 may include a material having relatively high thermal conductivity. Accordingly, the cooling efficiency of the battery cell assembly 120 may be improved.

In some cases, the first bent region 132 and the second bent region 133 may be formed of a different material from the body region 131. For example, the first bent region 132 and the second bent region 133 may also be formed of a material including metal, but may be formed of a different material from the body region 131.

FIG. 4 schematically illustrates a cross-section of a plurality of cooling members 130 according to an embodiment of the present disclosure. FIG. 4 illustrates the cooling members 130 as a cross-section in a thickness direction (X-direction) of the battery cell 121. Hatching lines are not illustrated in FIG. 4.

As illustrated in FIG. 4, in an embodiment of the present disclosure, the cooling member 130 may be applied by combining a plurality of cooling members 130. For example, an adhesive surface 136 may be formed on the body region 131 of the cooling member 130. The plurality of cooling members 130 may be coupled to the adhesive surfaces 136 by contacting the adhesive surfaces 136 in a state in which the adhesive surfaces 136 face each other.

In this case, the adhesive surface 136 may be provided with an adhesive material, such as tape or adhesive. Alternatively, the plurality of cooling members 130 may be coupled to each other using bolts or the like. A method of coupling the plurality of cooling members 130 is not necessarily limited by the present disclosure.

In the plurality of cooling members 130 coupled to each other, each of the first bent regions 132 may face each other with the respective body regions 131 interposed therebetween. Additionally, each second bent region 133 may face each other with the respective body regions 131 interposed therebetween.

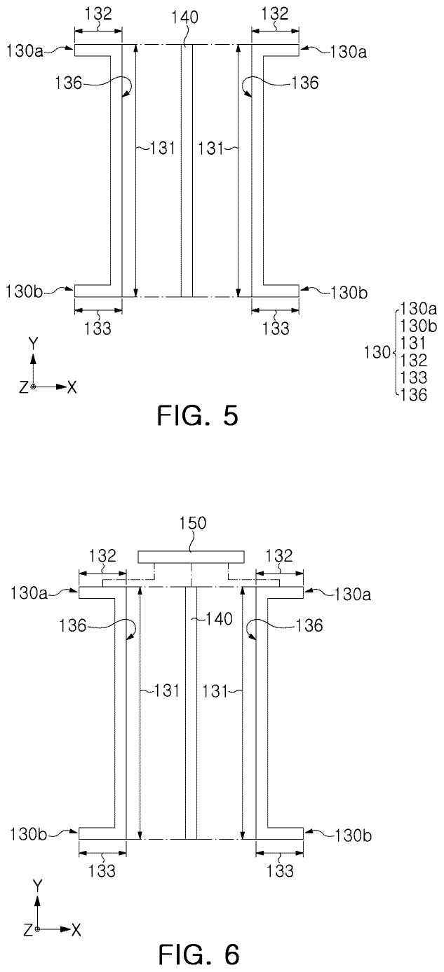

FIG. 5 schematically illustrates a cross-section of a plurality of cooling members 130 and an insulating member 140 according to an embodiment of the present disclosure. FIG. 5 illustrates a cross-section of the plurality of cooling members 130 and the insulating member 140 in a thickness direction (X-direction) cross-section of the battery cell 121. Hatching lines are not illustrated in FIG. 5.

As illustrated in FIG. 5, the insulating member 140 may be interposed between the plurality of cooling members 130 in an embodiment of the present disclosure.

The insulating member 140 may include a material having relatively low thermal conductivity. In an embodiment, the insulating member 140 may be formed of a different material from the cooling member 130 or the body region 131.

The insulating member 140 may face a plurality of body regions 131. Accordingly, the insulating member 140 may be interposed between the plurality of body regions 131. The insulating member 140 may be coupled to the plurality of cooling members 130. For example, one surface of the insulating member 140 may be coupled to the adhesive surface 136 of one cooling member 130, and the other surface of the insulating member 140 may be coupled to the adhesive surface 136 of another cooling member 130. In this case, an adhesive, tape, or the like may be applied to each adhesive surface 136. However, a coupling method is not necessarily limited by the present disclosure.

Furthermore, in an embodiment, the plurality of cooling members 130, each of the first bent regions 132 may face each other with the insulating member 140 interposed therebetween, and each of the second bent regions 133 may face each other with the insulating member 140 interposed therebetween. A height of the insulating member 140 may be at least equal to a height of the plurality of cooling members 130.

In an embodiment, a single insulating member 140 may be provided between the plurality of cooling members 130, for example, a pair of cooling members 130. In this manner, the pair of cooling members 130 and the single insulating member 140 may be coupled or fixed to each other to form a single cooling unit. This single cooling unit may be interposed between a pair of battery cells 121 to cool the battery cell assembly 120 and prevent thermal propagation of the battery cell assembly 120.

As illustrated in FIGS. 2 and 5, the body region 131 may be interposed between the plurality of battery cells 121 and may be disposed so as to face the electrode assembly accommodating space 113 of each of the plurality of battery cells 121. Accordingly, the insulating member 140 interposed between the body regions 131 and facing the body regions 131 may function as an insulating layer between the plurality of battery cells 121.

In an embodiment, the insulating member 140 may be formed of a material having lower thermal conductivity than the body region 131. Accordingly, the insulating member 140 may minimize or prevent the propagation and/or transfer of heat and/or flames between the battery cells 121 adjacent to each other. Accordingly, thermal propagation of the battery apparatus 100 may be minimized or prevented.

In an embodiment, the insulating member 140 may be formed of a material including mica.

Additionally, in an embodiment, the insulating member 140 may be formed of a material having lower thermal conductivity than the body region 131 or a material including mica.

FIG. 6 schematically illustrates cross-sections of plurality of cooling members 130, an insulating member 140, and a support member 150 according to an embodiment of the present disclosure. FIG. 6 illustrates the plurality of cooling members 130, the insulating member 140 and the support member 150 in a thickness direction (X-direction) cross-section of the battery cell 121. Hatching lines are not illustrated in FIG. 6.

As illustrated in FIGS. 2 and 6, in an embodiment of the present disclosure, the battery apparatus 100 may further include a support member 150 interposed between each of the first bent regions 132 and the case 110.

The support member 150 may be coupled to a pair of cooling members 130 and the insulating member 140 in a state in which the pair of cooling members 130 and the insulating member 140 have been fully coupled to each other. The coupling method of the support member 150 may be the same as the coupling method of the cooling member 130 and the insulating member 140 described above.

In the thickness-direction cross-section of the battery cell 121 or the thickness-direction cross-section of the cooling member 130, one surface of the support member 150 may cover a pair of first bent regions 132 and the insulating member 140. The other surface of the support member 150 may face or contact an inner surface of the first case 111.

The support member 150 may minimize or prevent clearance between the plurality of cooling members 130 and insulating member 140 and the first case 111. The support member 150 may improve the assemblability of the battery apparatus 100.

In an embodiment, the support member 150 may be formed of a material including at least one of polyurethane or silicone. In an embodiment, a shape of the support member 150 may be deformable. For example, the support member 150 may fill a space formed between the plurality of cooling members 130 and the first case 111 and/or a space formed between the insulating member 140 and the first case 111.

The support member 150 may be compressed or expanded depending on the volume of the space. The support member 150 may fill the space by deforming, compressing, or expanding a space thereof. Accordingly, the plurality of cooling members 130 and the first case 111 may be in close contact with each other, and the insulating member 140 and the first case 111 may be in close contact with each other. Furthermore, the clearance between the first case 111 and the plurality of cooling members 130 and the clearance between the first case 111 and the insulating member 140 may be minimized or prevented. This may contribute to improving the quality of the battery apparatus 100.

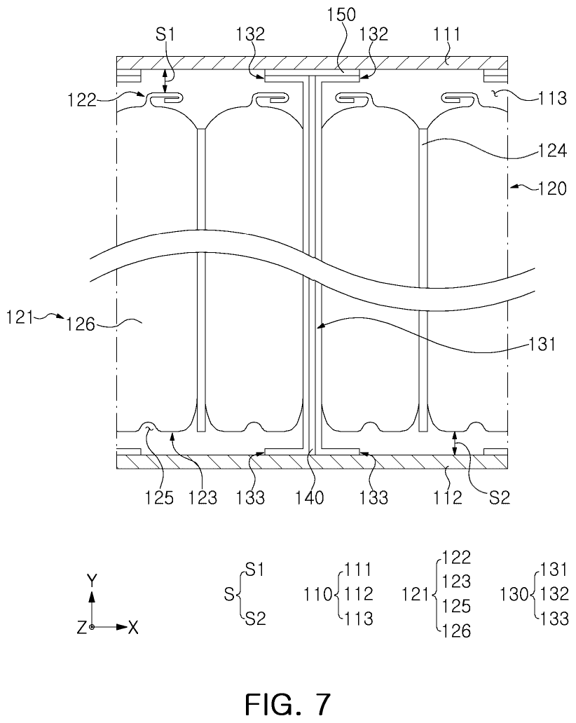

FIG. 7 schematically illustrates a partial cross-section of a battery apparatus 100 according to an embodiment of the present disclosure. In this case, FIG. 7 illustrates a cross-section of a battery cell 121 in the thickness direction, and illustrates a position corresponding to line I-I′ of FIG. 1. In FIG. 7, hatching lines for the battery cell 121, the cooling member 130, the insulating member 140, and the support member 150 are not depicted.

As illustrated in FIG. 7, in an embodiment of the present disclosure, a plurality of battery cells 121 may be spaced apart from the case 110. Furthermore, the first bent region 132 and the second bent region 133 may be disposed in a separation space S formed by separating the plurality of battery cells 121 from the case 110, and may face the case 110 in the separation space S.

The separation space S may be included in the accommodating space 113. In a thickness-direction cross-section (X-Y plane) of the battery cells 121, the separation space S may include a plurality of separation spaces S.

In an embodiment, the plurality of battery cells 121 may be spaced apart from the first bent region 132 and the second bent region 133.

The plurality of separation spaces S may include a first separation space S1, which is a space formed by separating the inner surface of the first case 111 from the battery cell 121, and a second separation space S2, which is formed by separating an inner surface of the second case 112 from the bottom surface 123 of the battery cell 121. For example, the first separation space S1 may be a space formed by separating the sealing portion 122 of the battery cell 121 from the inner surface of the first case 111. The second separation space S2 may be a space formed by separating the bottom surface 123 of the battery cell 121 from the inner surface of the second case 112.

The first bent region 132 may be disposed in the first separation space S1, and the second bent region 133 may be disposed in the second separation space S2. That is, the first bent region 132 may be disposed between the sealing portion 122 and the first case 111, and the second bent region 133 may be disposed between the bottom surface 123 of the battery cell 121 and the second case 112.

A cooling fluid may be present in the first separation space S1 and the second separation space S2. In this case, the cooling fluid may be present anywhere in the accommodating space 113. The above-described first separation space S1 and the above-described second separation space S2 may be included in the accommodating space 113, and the accommodating space 113 may be formed between a plurality of battery cells 121, and may also include a separation space formed when the plurality of battery cells 121 are spaced apart from each other in the thickness direction (X-direction) of the battery cells.

The first bent region 132, the body region 131 and the second bent region 133 may be immersed in the cooling fluid. In this case, since the cooling fluid is present in the accommodating space 113, the battery cell assembly 120 may also be immersed in the cooling fluid.

Regions having a relatively large amount of cooling fluid within the accommodating space 113 may be a first separation space and a second separation space. Accordingly, an area in which the first bent region 132 and the second bent region 133 are in contact with the cooling fluid may increase. Accordingly, the cooling efficiency of the battery cell assembly 120 may be improved.

Furthermore, for example, one end (+Y-direction end) of the insulating member 140 may be in contact with the support member 150, and the other end (−Y-direction end) of the insulating member 140 may be in contact with the inner surface of the second case 112. Accordingly, a pair of battery cells 121 may be isolated from each other in the thickness direction (X-direction) of the battery cell 121.

In an embodiment, the battery cell 121 may include an exterior material 126 forming an exterior, and an electrode assembly and an electrolyte may be accommodated within the exterior material 126. The exterior material 126 may be sealed and may include at least one sealing portion 122. In an embodiment, the battery cell 121 may be a pouch-type battery cell 121.

The exterior material 126 may be in the form of a film in which polyethylene terephthalate (PET), nylon and aluminum are stacked.

In an embodiment, a cooling groove 125 may be formed on the bottom surface 123 of the battery cell 121. The cooling groove 125 may be implemented by forming the exterior material 126 concavely in a direction facing the electrode assembly.

The cooling groove 125 may increase a contact area between the bottom surface 123 of the battery cell 121 and the cooling fluid. Accordingly, the cooling efficiency of the battery cell 121 may be improved.

In an embodiment, each of the first bent region 132 and the support member 150 may have a height higher than a height of one end of the battery cell 121 in the thickness-direction cross-section (X-Y plane) of the plurality of battery cells 121. In this case, the one end of the battery cell 121 may be the sealing portion 122 of the battery cell 121. For example, the one end of the battery cell 121 may be an end of the sealing portion 122 of the battery cell 121 in the +Y-direction.

Furthermore, in an embodiment, a height of the support member 150 in the thickness-direction cross-section (X-Y plane) of the plurality of battery cells 121 may be higher than a height of the first bent region 132.

Additionally, in an embodiment, the support member 150 may also be disposed between the second bent region 133 and the second case 112, but the presence of the support member 150 in a region corresponding to the second bent region 133 is not necessarily limited by the present disclosure.

The support member 150 may contact a pair of first bent regions 132 adjacent to or facing each other, and in some cases, the support member 150 may contact a pair of second bent regions 133 adjacent to or facing each other.

Additionally, in an embodiment, with respect to the support member 150, a single support member 150 or one support member 150 may be provided on an entire inner surface of the first case 111. For example, a width of the support member 150 in the thickness direction (X-direction) of the battery cell 121 may be at least equal to a width of the battery cell assembly 120. In other words, the one support member 150 or the single support member 150 may cover all of upper portions of the plurality of battery cells 121 (or the upper portions of the sealing portions 122), the plurality of first bent regions 132, and the plurality of insulating members 140. This may improve the assembly efficiency of the battery apparatus 100.

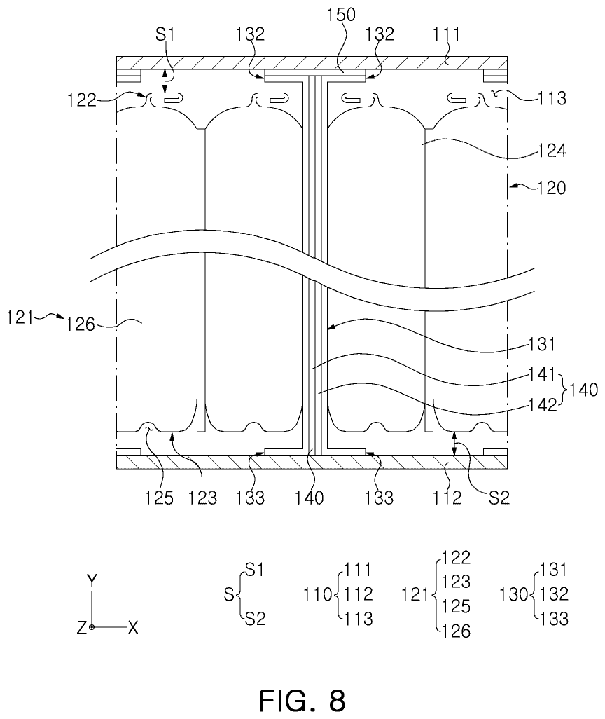

FIG. 8 schematically illustrates a partial cross-section of a battery apparatus 100 according to an embodiment of the present disclosure. FIG. 8 illustrates a cross-section of a battery cell 121 in the thickness direction, and illustrates a position corresponding to line I-I′ of FIG. 1. In FIG. 8, hatching lines for the battery cell 121, the cooling member 130, the insulating member 140 and the support member 150 are not depicted.

As illustrated in FIG. 8, in an embodiment, the insulating member 140 may be provided in plural, and a plurality of insulating members 140 may be formed of different materials.

For example, the plurality of insulating members 140 may include a first insulating member 141 facing a body region 131 of one cooling member 130 of the plurality of cooling members 130, and a second insulating member 142 interposed between the first insulating member 141 and a body region 131 of another cooling member 130 of the plurality of cooling members 130, and formed of a different material from the first insulating member 141.

The first insulating member 141 and the second insulating member 142 may be in contact with each other and may be interposed between the plurality of body regions 131. The first insulating member 141 and the second insulating member 142 may be respectively fixed to the plurality of body regions 131. In this case, the plurality of body regions 131 may be body regions 131 of different cooling members 130. Accordingly, the insulation performance of the battery cell assembly 120 may be improved, and thermal propagation of the battery apparatus 100 may be minimized or prevented.

In an embodiment, the first insulating member 141 may be formed of a material including mica or silicone.

Furthermore, in an embodiment, the second insulating member 142 may be formed of a material including mica or silicone.

However, when the first insulating member 141 is formed of mica, the second insulating member 142 may be formed of silicone, and when the first insulating member 141 is formed of silicone, the second insulating member 142 may be formed of mica. Accordingly, insulation efficiency may be improved and the surface pressure of the battery cell 121 may be provided.

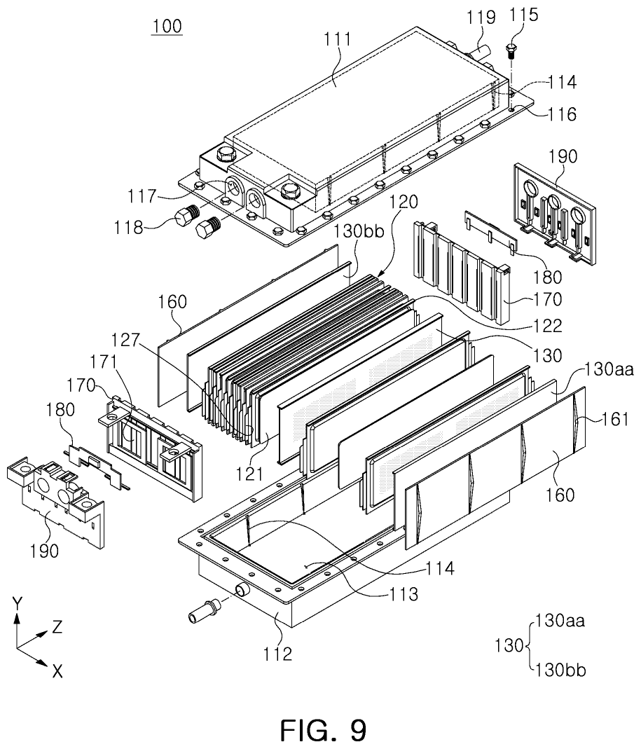

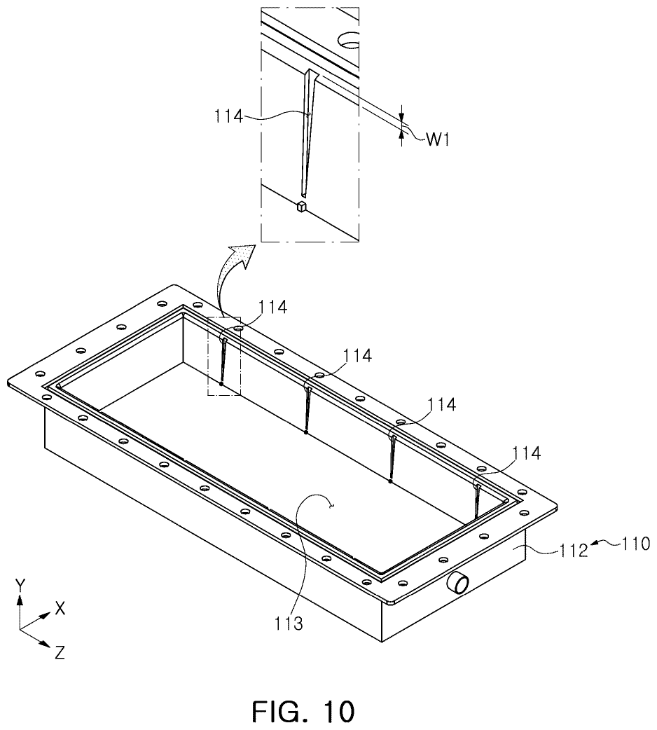

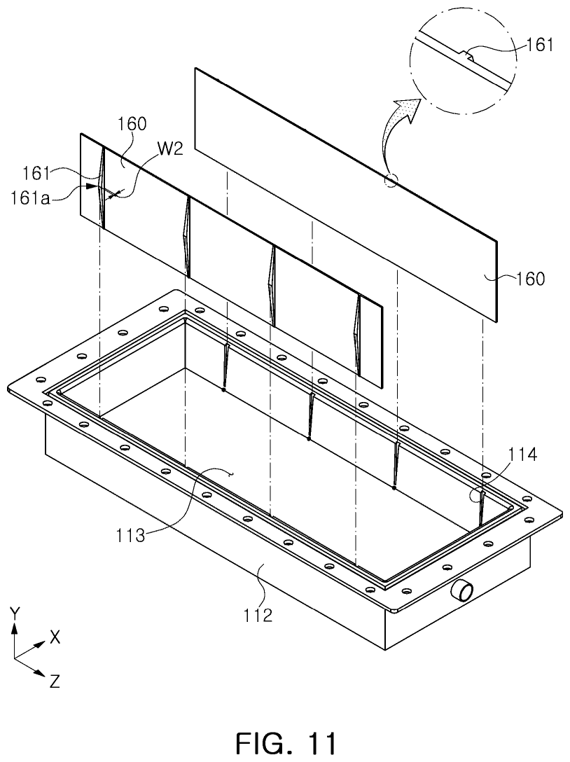

FIG. 9 is a schematic exploded perspective view of a battery apparatus 100 according to another embodiment of the present disclosure, FIG. 10 is a schematic perspective view of the second case 112, and FIG. 11 is a schematic exploded perspective view of a second case 112 and a plurality of plate members 160.

As illustrated in FIGS. 2, 9 and 11, the battery apparatus 100 according to an embodiment of the present disclosure may further include a plurality of plate members 160 surrounding a plurality of battery cells 121, disposed between the plurality of battery cells 121 and the case 110 in the accommodating space 113, and including at least one assembly support protrusion 161. Additionally, the case 110 may be formed on an inner surface facing the plurality of plate members 160 and may include at least one assembly support groove 114 into which at least one assembly support protrusion 161 is inserted.

In an embodiment, the plurality of cooling members 130 may have a width at least equal to a width of the battery cell 121. The plurality of cooling members 130 may cover a region corresponding to the electrode assembly accommodating space 113 in the battery cell 121.

In an embodiment, the battery apparatus 100 may include at least one exhaust hole 117 on one side of the first case 111, and at least one exhaust hole 117 may be connected to the accommodating space 113. The at least one exhaust hole 117 may be closed by at least one exhaust valve 118.

For example, the at least one exhaust hole 117 may include a plurality of exhaust holes 117, and the at least one exhaust valve 118 may include a plurality of exhaust valves 118. One exhaust valve 118 may be inserted into one exhaust hole 117. For example, the exhaust valve 118 may be provided in the form of a shaft capable of closing the exhaust hole 117 and may be detachably provided in the exhaust hole 117. However, the shapes of the exhaust hole 117 and the exhaust valve 118 are not necessarily limited by the present disclosure. By separating the exhaust valve 118 from the exhaust hole 117 and opening the exhaust hole 117, the pressure in the accommodating space 113 may be controlled.

In an embodiment, the battery cell 121 may include a plurality of electrode leads 127. The plurality of electrode leads 127 may be electrically connected to a cathode plate and an anode plate of the battery cell 121, respectively, and may be exposed to the outside of the battery cell 121.

The plurality of electrode leads 127 may be connected to a plurality of busbar members 171, respectively. The plurality of busbar members 171 may be included in a busbar assembly 170. The busbar assembly 170 may include the plurality of busbar members 171 and a busbar plate supporting the plurality of busbar members 171. The busbar plate may be formed of a material having electrical insulation. The busbar assembly 170 may be provided in plural, and a plurality of busbar assemblies 170 may be provided on one side and the other side of the battery cell assembly 120, respectively.

For example, one busbar member 171 and one busbar plate may be disposed on one side of the battery cell assembly 120, and another busbar member 171 and another busbar plate may be disposed on the other side of the battery cell assembly 120. In this case, since the battery cell assembly 120 includes a plurality of battery cells 121, the one busbar member 171 disposed on one side of the battery cell assembly 120 may be understood as a plurality of busbar members 171, and the one busbar member 171 disposed on the other side of the battery cell assembly 120 may also be understood as a plurality of busbar members 171.

The busbar member 171 may be connected to a sensing assembly 180. The sensing assembly 180 may be provided in plural, and a plurality of sensing assemblies 180 may be respectively disposed on one side and the other side of the battery cell assembly 120. The sensing assembly 180 may include a printed circuit board (PCB) and may be electrically connected to a plurality of battery cells 121. In some cases, when the battery cell assembly 120 includes a temperature sensor, a voltage sensor, and the like, the sensing assembly 180 may be connected to the temperature sensor and the voltage sensor.

In an embodiment, the sensing assembly 180 and the busbar assembly 170 may be covered by an insulating cover 190. The insulating cover 190 may be provided in plural, and a plurality of insulating covers 190 may be respectively disposed on one side and the other side of the battery cell assembly 120. The plurality of insulating covers 190 may be formed of a material having electrical insulation properties.

In an embodiment, a battery cell 121 disposed in an outermost end of one side of the battery cell assembly 120 may face a first outermost cooling member 130aa, and a battery cell 121 disposed in an outermost end of the other side of the battery cell assembly 120 may face a second outermost cooling member 130bb. For example, the cross-sectional shapes of the first outermost cooling member 130aa and the second outermost cooling member 130bb may be in the shape of a ‘]’ and/or a ‘[’.

The plate member 160 may be disposed between the first outermost cooling member 130aa and the case 110, and the plate member 160 may also be disposed between the second outermost cooling member 130bb and the case 110.

The plate member 160 may be formed of a material having electrical insulation. The plate member 160 may be provided in plural. Each plate member 160 may include at least one assembly support protrusion 161. The assembly support protrusion 161 may protrude in a direction oriented toward the case 110.

The case 110 may include at least one assembly support groove 114 on one surface facing the assembly support protrusion 161. The assembly support protrusion 161 may be inserted into the assembly support groove 114. The assembly support groove 114 may be provided in a shape corresponding to the assembly support protrusion 161.

The assembly support protrusions 161 may be provided continuously in a height direction (Y-direction) of the plate member 160. The assembly support grooves 114 may also be provided continuously in a height direction (Y-direction) of the case 110 or in a height direction of the plate member 160.

The assembly support groove 114 may be provided in the first case 111 and the second case 112. When the first case 111 and the second case 112 are coupled, the assembly support grooves 114 provided in each of the first case 111 and the second case 112 may be coupled to form one assembly support groove 114. Alternatively, when the first case 111 and the second case 112 are coupled, the assembly support grooves 114 provided in each of the first case 111 and the second case 112 may be connected to each other. In this case, the assembly support grooves 114 provided in each of the first case 111 and the second case 112 may be connected in a height direction of the first case 111 or a height direction of the second case 112.

In an embodiment, when the plate member 160 is stored in the accommodating space 113, the assembly support protrusion 161 may be moved along the assembly support groove 114 formed in the second case 112 as illustrated in FIG. 10. In this case, the assembly support protrusion 161 may be inserted into the assembly support groove 114 in an end of the second case 112 in the +Y-direction, and the plate member 160 may be moved in the −Y-direction in a state in which the assembly support protrusion 161 is inserted into the assembly support groove 114. Then, as illustrated in FIG. 9, in a state in which the assembly support protrusion 161 is inserted into the assembly support groove 114 formed in the first case 111, when the first case 111 is moved in the −Y-direction, the assembly of the first case 111 and the second case 112 may be completed. Accordingly, the assembly efficiency of the plate member 160 may be improved, and the assembly efficiency of the first case 111 and the second case 112 may also be improved.

In an embodiment, as illustrated in FIG. 10, when a width W1 of the assembly support groove 114 is referred to as a width W1 of the assembly support groove 114 in the thickness direction of the battery cell 121, the width W1 of the assembly support groove 114 may be widest in the end of the second case 112 in the +Y-direction and may be narrowest on the bottom surface 123 of the second case 112 or in the end of the second case 112 in the −Y-direction. Furthermore, the width W1 of the assembly support groove 114 may become narrower toward the bottom surface 123 of the second case 112 or the end of the second case 112 in the −Y-direction.

In this case, the shape of the assembly support protrusion 161 may be formed to correspond to the shape of the assembly support groove 114. For example, when a width W2 of the assembly support protrusion 161 is referred to as a width W2 of the assembly support protrusion 161 in the thickness direction of the battery cell 121, the width W2 of the assembly support protrusion 161 may be less than or equal to the width W1 of the assembly support groove 114. Furthermore, for example, a maximum width W1 of the assembly support groove 114 may be greater than or equal to a maximum width W2 of the assembly support protrusion 161.

In an embodiment, the shape of the assembly support protrusion 161 may be deformed based on a reference point 161a. For example, the assembly support protrusion 161 may have a maximum width W2 at the reference point 161a. The width W2 of the assembly support protrusion 161 may decrease as the assembly support protrusion 161 moves in the +Y-direction with respect to the maximum width W2 of the assembly support protrusion 161. In addition, the width W2 may decrease in the −Y-direction with respect to the maximum width W2. In this case, a width of the assembly support protrusion 161 may be the shortest distance from one surface of the plate member 160 to a region in which the assembly support protrusion 161 protrudes, but may be the shortest distance in a direction, parallel to the X-axis.

The aforementioned assembly support protrusion 161 and assembly support groove 114 may be provided in plural, and one assembly support protrusion 161 may be inserted into the assembly support groove 114 formed in the first case 111 and the assembly support groove 114 formed in the second case 112.

Furthermore, a plurality of assembly support protrusions 161 may be formed in one plate member 160, and the plurality of assembly support protrusions 161 on the one plate member 160 may be spaced apart from each other in a width direction of the battery cell 121.

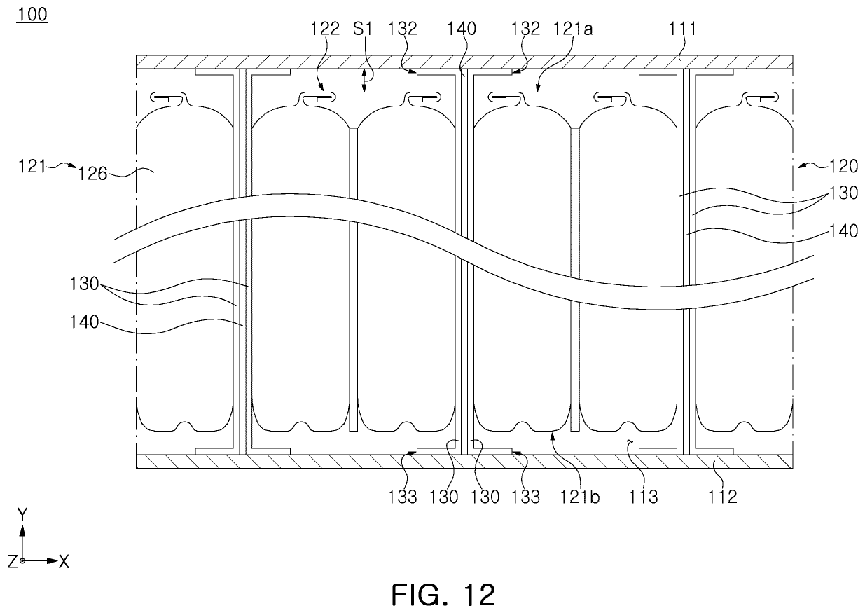

FIG. 12 is a schematic cross-sectional view of a battery apparatus 100 according to an embodiment of the present disclosure. FIG. 12 is a cross-section corresponding to line I-I′ of FIG. 1, and in FIG. 12, hatching lines of a battery cell 121, a pad member 124, a cooling member 130, an insulating member 140 and a support member 150 are omitted.

As illustrated in FIG. 12, a battery apparatus 100 according to an embodiment of the present disclosure may include a case 110 including an insulating oil or a cooling water in an accommodating space 113, a battery cell assembly 120 including a plurality of battery cells 121 immersed in the insulating oil or the cooling water in the accommodating space 113 and spaced apart from the case 110, a plurality of cooling members 130 interposed between the plurality of battery cells 121, and an insulating member 140 interposed between the plurality of cooling members 130 and formed of a different material from the plurality of cooling members 130. In this case, the plurality of cooling members 130 may each include a bent region disposed in a separation space formed by separating the plurality of battery cells 121 from the case 110 in the accommodating space 113.

In an embodiment, the bent region may include a first bent region 132 facing one side 121a of the battery cell 121 and a second bent region 133 facing the other side 121b of the battery cell 121.

The support member 150 may be disposed between the first bent region 132 and the first case 111. Additionally, the insulating member 140 may be interposed between the plurality of cooling members 130. In this case, the plurality of cooling members 130 and the insulating member 140 may be coupled or fixed to each other.

A cross-sectional shape of the plurality of cooling members 130 and the insulating member 140 may be an “I” shape. The plurality of cooling members 130 and the insulating member 140 may be interposed between a pair of battery cells 121.

The plurality of cooling members 130 may be formed of a material having relatively high thermal conductivity, and the insulating member 140 may be formed of a material having relatively low thermal conductivity. For example, the thermal conductivity of the insulating member 140 may be lower than the thermal conductivity of the plurality of cooling members 130. Furthermore, for example, the insulating member 140 may be formed of a material including mica, and the plurality of cooling members 130 may be formed of a material including at least one of aluminum, stainless steel, or the like.

The plurality of cooling members 130 may improve the cooling efficiency of the battery cell assembly 120, and the insulating member 140 may minimize or block heat transfer or heat transmission between the plurality of battery cells 121.

Accordingly, the cooling efficiency of the battery apparatus 100 may be improved, while also minimizing or preventing thermal propagation of the battery apparatus 100.

Furthermore, in some cases, the materials of the first bent region 132 and the body region 131 of the plurality of cooling members 130 may be different, and the material of the body region 131 may also be different from the material of the second bent region 133. In this case, the materials of the first bent region 132 and the second bent region 133 may be identical to or different from each other.

The above-described explanation is merely an example of applying the principles of the present disclosure. Other components may be incorporated or substituted without departing from the scope of the present disclosure. Furthermore, the present disclosure may be implemented by deleting or modifying some of the components in the aforementioned embodiments. Furthermore, the present disclosure may be implemented in each embodiment alone or in combination with other embodiments.

What is claimed is:

1. A battery apparatus comprising:
a case including an accommodating space;
a battery cell assembly accommodated in the case and including a plurality of battery cells;
a cooling fluid provided in the accommodating space; and
at least one cooling member interposed between the plurality of battery cells,
wherein the at least one cooling member includes:
a body region interposed between the plurality of battery cells;
a first bent region bent on one side of the body region; and
a second bent region bent on the other side of the body region.

2. The battery apparatus of claim 1, further comprising:
an insulating member interposed between the plurality of cooling members.

3. The battery apparatus of claim 2, wherein the insulating member is formed of a different material from the body region.

4. The battery apparatus of claim 2, wherein in the plurality of cooling members, each of first bent regions faces each other with the insulating member interposed therebetween, and each of second bent regions faces each other with the insulating member interposed therebetween.

5. The battery apparatus of claim 3, wherein the insulating member is formed of a material having lower thermal conductivity than the body region or a material including mica.

6. The battery apparatus of claim 3, wherein the body region is formed of a material including metal.

7. The battery apparatus of claim 1, wherein the plurality of battery cells are spaced apart from the case, and
the first bent region and the second bent region are disposed in a separation space formed by separating the plurality of battery cells from the case, and face the case in the separation space.

8. The battery apparatus of claim 1, wherein the first bent region and the second bent region face each other in a thickness-direction cross-section of the at least one cooling member.

9. The battery apparatus of claim 4, further comprising:
a support member interposed between each of the first bent regions and the case.

10. The battery apparatus of claim 9, wherein the support member is formed of a material including at least one of polyurethane and silicone.

11. The battery apparatus of claim 9, wherein each of the first bent regions and the support member have a height higher than a height of one end of the battery cells in a thickness-direction cross-section of the plurality of battery cells.

12. The battery apparatus of claim 1, wherein the plurality of battery cells are spaced apart from the first bent region and the second bent region.

13. The battery apparatus of claim 2, wherein the insulating member is provided in plural, and a plurality of insulating members are formed of different materials.

14. The battery apparatus of claim 13, wherein the plurality of insulating member include:
a first insulating member facing a body region of one cooling member of the plurality of cooling members; and
a second insulating member interposed between the first insulating member and a body region of another cooling member of the plurality of cooling members,
wherein the second insulating member is formed of a different material from the first insulating member.

15. The battery apparatus of claim 14, wherein the first insulating member is formed of a material including mica or silicone.

16. The battery apparatus of claim 14, wherein the second insulating member is formed of a material including mica or silicone.

17. The battery apparatus of claim 1, further comprising:
a plurality of plate members surrounding the plurality of battery cells and disposed between the plurality of battery cells and the case in the accommodating space, and including at least one assembly support protrusion,
wherein the case includes:
at least one assembly support groove formed on an inner surface facing the plurality of plate members and into which the at least one assembly support protrusion is inserted.

18. The battery apparatus of claim 1, wherein the cooling fluid includes an insulating oil, and
the battery cell assembly and the at least one cooling member are immersed in the cooling fluid.

19. A battery apparatus, comprising:
a case including an insulating oil or a cooling water in an accommodating space;
a battery cell assembly including a plurality of battery cells immersed in the insulating oil or the cooling water in the accommodating space and spaced apart from the case;
a plurality of cooling members interposed between the plurality of battery cells; and
an insulating member interposed between the plurality of cooling members and formed of a different material from the plurality of cooling members,
wherein the plurality of cooling members respectively include a bent region disposed in a separation space formed by separating the plurality of battery cells from the case in the accommodating space.

20. The battery apparatus of claim 19, wherein the bent region includes:
a first bent region facing one side of the battery cell; and
a second bent region facing the other side of the battery cell.
